(19) United States
(12) Patent Application Publication
(10) Pub. No.: US 2025/0361987 A1
(43) Pub. Date: Nov. 27, 2025

(54) SYSTEMS AND METHODS FOR MONITORING VALVE STATUS

(71) Applicant: Nikola Corporation, Phoenix, AZ (US)

(72) Inventors: Baltazar Gonzalez Leon, Glendale, AZ (US); Shruti Patil, Phoenix, AZ (US); Maria Elizabeth Saade Saade, San Jose, CA (US); Ian Saltwick, Phoenix, AZ (US); Rahul Shetty, Chandler, AZ (US); Kushalbhai N. Vashi, Tempe, AZ (US); Renju Zacharia, Gilbert, AZ (US)

(21) Appl. No.: 19/214,928

(22) Filed: May 21, 2025

Related U.S. Application Data
(60) Provisional application No. 63/651,745, filed on May 24, 2024.

(51) Int. Cl. F17C 13/04; F16K 37/00

(52) U.S. Cl. CPC F17C 13/04; F16K 37/0091; F17C 2205/0326; F17C 2205/0338; F17C 2221/012; F17C 2250/043; F17C 2270/0171; F17C 2270/0184

(57) ABSTRACT

The present disclosure provides systems and methods for monitoring for a stuck valve. Various temperature and pressure sensors are used to monitor for a stuck valve in one or more tanks of hydrogen gas.

### CROSS-REFERENCE TO RELATED APPLICATIONS

This application claims priority to, and the benefit of, U.S. Provisional Patent Application No. 63/651,745 filed on May 24, 2024 entitled “SYSTEMS AND METHODS FOR MONITORING VALVE STATUS.” The disclosure of the foregoing application is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to systems for monitoring hydrogen gas, and more particularly, to monitoring hydrogen gas used as fuel in, for example, fuel cell vehicles.

### BACKGROUND

Fuel cell electric vehicles (FCEVs) facilitate oxidation-reduction (redox) reactions between oxygen and hydrogen in a fuel cell system to generate electrical energy. More specifically, as hydrogen enters the fuel cell system, electrons are disassociated from hydrogen molecules and passed through an external circuit in order to perform work, while protons are passed through an internal membrane. At the cathode, the protons recombine with the electrons and oxygen in an exothermic reaction to form water and heat, which are exhausted to the external environment along with some amount of unreacted hydrogen and air. Given the care with which hydrogen gas should be handled, monitoring fuel storage systems that house hydrogen gas is important for safety, among other things.

### SUMMARY

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

In various embodiments, a hydrogen storage system for a fuel cell electric vehicle (FCEV) is provided, comprising: a controller in electronic communication with an on tank valve (OTV) associated with an OTV of a first tank, a pressure regulator pressure sensor associated with a pressure regulator in electronic communication with the controller (the pressure regulator being in fluid communication with at least one of a fuel cell supply line, a manifold, or a plumbing system and the pressure regulator pressure sensor configured to sense a pressure in the at least one of the fuel cell supply line, the manifold, or the plumbing system), and a non-transitory computer-readable storage medium in electronic communication with the controller, the computer-readable storage medium having instructions stored thereon that, in response to execution by the controller, cause the controller to perform operations comprising: receiving, by the controller and during at least one of a driving condition, a park preparation condition, or a low fuel cell power demand condition, a first pressure from the pressure regulator pressure sensor representing at least one of the fuel cell supply line, the manifold, or the plumbing system; commanding, by the controller, the OTV to close for a predetermined time interval; receiving, by the controller, a second pressure from the pressure regulator pressure sensor representing at least one of the fuel cell supply line, the manifold, or the plumbing system; determining, by the controller, the absolute value of the difference between the first pressure and the second pressure to yield an absolute pressure difference; determining, by the controller, whether the absolute pressure difference is greater than a predetermined threshold; and in response to finding that the absolute pressure difference is less than the predetermined threshold, transmitting, by the controller, a stuck OTV fault.

In various embodiments, an article of manufacture is provided including a tangible, non-transitory, computer-readable storage medium in electronic communication with a controller, having instructions stored thereon that, in response to execution by the controller, cause the controller to perform operations comprising: receiving, by the controller during at least one of a driving condition, a park preparation condition, or a low fuel cell power demand condition, a first pressure from a pressure regulator pressure sensor representing at least one of a fuel cell supply line, a manifold, or a plumbing system; commanding, by the controller, the OTV to close for a predetermined time interval; receiving, by the controller, a second pressure from the pressure regulator pressure sensor representing at least one of the fuel cell supply line, the manifold, or the plumbing system; determining, by the controller, the absolute value of the difference between the first pressure and the second pressure to yield an absolute pressure difference; determining, by the controller, whether the absolute pressure difference is greater than a predetermined threshold; and in response to finding that the absolute pressure difference is greater than the predetermined threshold, transmitting, by the controller, a stuck OTV fault.

In various embodiments, a method is provided, comprising: receiving, by the controller during at least one of a driving condition, a park preparation condition, or a low fuel cell power demand condition, a first pressure from a pressure regulator pressure sensor representing at least one of a fuel cell supply line, a manifold, or a plumbing system; commanding, by the controller, an OTV to close for a predetermined time interval; receiving, by the controller, a second pressure from the pressure regulator pressure sensor; determining, by the controller, the absolute value of the difference between the first pressure and the second pressure to yield an absolute pressure difference; determining, by the controller, whether the absolute pressure difference is greater than a predetermined threshold; and in response to finding that the absolute pressure difference is greater than the predetermined threshold, transmitting, by the controller, a stuck OTV fault.

### BRIEF DESCRIPTION OF THE DRAWINGS

The accompanying drawings are included to provide a further understanding of the present disclosure and are incorporated in and constitute a part of this specification, illustrate various embodiments, and together with the description, serve to explain exemplary principles of the disclosure.

FIG. 1 illustrates a perspective view of an FCEV, in accordance with various embodiments;

FIG. 2 illustrates a bottom view of an FCEV, in accordance with various embodiments;

FIGS. 3A and 3B illustrate an arrangement of tanks, in accordance with various embodiments;

FIG. 4 illustrates a valve diagnostic system, in accordance with various embodiments;

FIG. 5 illustrates a valve diagnostic, in accordance with various embodiments;

FIG. 6 illustrates a valve diagnostic, in accordance with various embodiments;

FIG. 7 illustrates a valve diagnostic, in accordance with various embodiments;

FIG. 8 illustrates a valve diagnostic, in accordance with various embodiments;

FIG. 9 illustrates a relationship between pressure, time, and valve status, in accordance with various embodiments;

FIG. 10 illustrates a stuck valve identification diagnostic, in accordance with various embodiments;

FIG. 11 illustrates a stuck valve identification diagnostic, in accordance with various embodiments;

FIG. 12 illustrates a stuck valve identification diagnostic, in accordance with various embodiments; and

FIG. 13 illustrates a stuck valve identification diagnostic, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”) and/or a radio frequency (RF) communications protocol. In this regard, “electronic communication” as used herein includes wired and wireless communications (e.g., Bluetooth, Bluetooth LE, NFC, TCP/IP, Wi-Fi, etc.).

In the context of the present disclosure, methods, systems, and articles may find particular use in connection with medium-and heavy-duty FCEVs. However, various aspects of the disclosed embodiments may be adapted for performance in a variety of other systems, including gasoline/electric hybrid vehicles, compressed natural gas (CNG) vehicles, hythane (mix of hydrogen and natural gas) vehicles, and/or the like. Accordingly, numerous applications of the present disclosure may be realized.

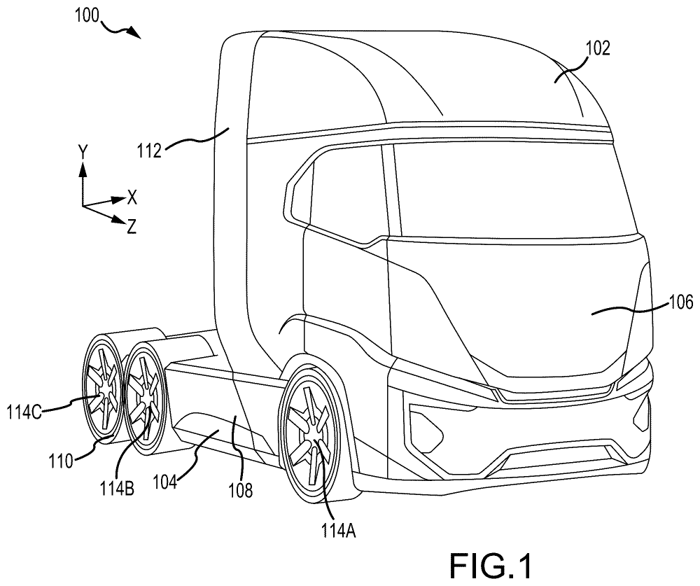

Accordingly, with reference to FIG. 1, an FCEV 100 is illustrated from a top perspective view, in accordance with various embodiments. As illustrated in FIG. 1, FCEV 100 is a heavy-duty FCEV. FCEV 100 is a tractor unit which may tow a trailer unit configured to hold and transport cargo. FCEV 100 may comprise a class 8, class 7, class 6, or any other weight classification of tractor-trailer combination. As described herein, FCEV 100 extends in a longitudinal direction along the Z-axis from a rear of FCEV 100 to a front of FCEV 100. FCEV 100 extends in a transverse direction along the X-axis from a passenger side of FCEV 100 to a driver side of FCEV 100. Finally, FCEV 100 extends in a vertical direction along the Y-axis from a ground surface on which FCEV 100 drives to a top of FCEV 100.

FCEV 100 comprises a cab 102 supported by a chassis 104. Cab 102 may be configured to shelter one or more vehicle operators or passengers from the external environment. In various embodiments, cab 102 comprises a door configured to allow ingress and egress into and from cab 102, one or more seats, a windshield, and numerous accessories configured to improve comfort for the operator and/or passenger(s). As illustrated in FIG. 1, FCEV 100 comprises a cab-over or cab-forward style tractor unit, but is not limited in this regard and may comprise any style of tractor unit including a conventional or American cab style tractor unit.

Chassis 104, otherwise known as the vehicle frame, is configured to support various components and systems of FCEV 100 including cab 102. Chassis 104 may comprise a ladder-like structure with various mounting points for FCEV 100′s suspension, powertrain, energy storage systems (ESS) (for example, fuel cell system(s) and/or battery system(s)), and other systems. Chassis 104 supports and is coupled to a fuel cell system 106 which may be configured to facilitate an electrochemical reaction in order to generate electrical energy that can be used to drive FCEV 100 and operate electric components and systems of FCEV 100. Chassis 104 may be covered by one or more side covers 108 configured to provide corrosion-resistance and improved aerodynamics along the sides of FCEV 100. FCEV 100 further comprises wheels 110 comprising one or more tires coupled to one or more axles 114 and configured to roll along a driving surface. In various embodiments, FCEV 100 comprises a pair of single wheels coupled to a front axle 114A and a pair of dual wheels coupled to two rear axles (first rear axle 114B and second rear axle 114C). One or more of the axles may be driven. For example, in various embodiments, FCEV 100 may comprise a 6×2 configuration with a single driven axle; however, FCEV 100 is not limited in this regard and may comprise a 4×2, 6×4, 6×6, or other suitable configuration. In various embodiments, FCEV 100 may further comprise a hydrogen storage system 112 configured to contain and deliver hydrogen fuel to fuel cell system 106.

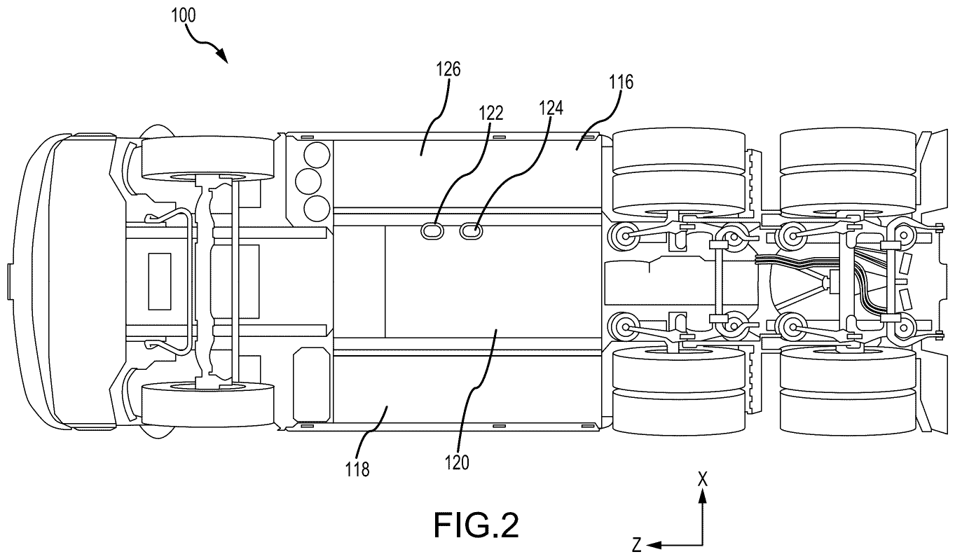

With reference to FIG. 2, FCEV 100 is illustrated from a bottom view, in accordance with various embodiments. In various embodiments, FCEV 100 comprises an undercarriage 116 that comprises a first outboard skid plate 118, an inboard skid plate 120, and a second outboard skid plate 126. First outboard skid plate 118 is positioned adjacent to the passenger side of FCEV 100 and is coupled to a first frame rail of chassis 104 on a first side and coupled to a first side cover 108 on a second side. Similarly, second outboard skid plate 126 is positioned adjacent to the driver side of FCEV 100 and is coupled to a second frame rail of chassis 104 on a first side and coupled to a second side cover 108 on a second side. Inboard skid plate 120 is positioned between the first outboard skid plate 118 and the second outboard skid plate 126 and is coupled to the first frame rail of chassis 104 on a first side and coupled to the second frame rail of chassis 104 on a second side.

Inboard skid plate 120 comprises a first exhaust aperture 122 and a second exhaust aperture 124 adjacent to and rearward of first exhaust aperture 122. As illustrated, first exhaust aperture 122 and second exhaust aperture 124 extend through inboard skid plate 120 adjacent to second outboard skid plate 126. More specifically, first exhaust aperture 122 and second exhaust aperture 124 are located adjacent to and inboard of the second frame rail of chassis 104; however, the positioning of first exhaust aperture 122 and second exhaust aperture 124 is not limited in this regard. The apertures may be positioned adjacent to and inboard of the first frame rail of chassis 104, centered in the transverse direction on inboard skid plate 120, or positioned at any suitable location in the transverse location on first outboard skid plate 118 or second outboard skid plate 126. Moreover, while illustrated as comprising two separate exhaust apertures, FCEV 100 is not limited in this regard and may comprise a single exhaust aperture in various embodiments.

In various embodiments, first exhaust aperture 122 and second exhaust aperture 124 are configured to permit exhaust gases and water to exit fuel cell system 106 (and FCEV 100) and be delivered to the external environment (for example, to the ground). More specifically, as fuel cell system 106 operates, fuel cell system 106 generates water and/or water vapor and heat to be exhausted to the external environment along with some amount of unreacted hydrogen and air. In various embodiments, first exhaust aperture 122 and second exhaust aperture 124 overlap with fuel cell system 106 in the transverse direction and are positioned rearward of fuel cell system 106. First exhaust aperture 122 and second exhaust aperture 124 may be located such that one or more exhaust ducts extending between fuel cell system 106 and the exhaust apertures occupy reduced and/or minimized volume on FCEV 100.

The storage, fueling, defueling, and use of compressed gases such as hydrogen gas (H₂) in a vehicle may be associated with enhanced energy efficiency, improved environmental impact profile, and decreased reliance on fossil fuels. As discussed above, hydrogen gas may be combined with oxygen in a fuel cell to yield electrical energy and water. This reduces or eliminates the need for a vehicle to consume fossil fuels directly and/or emit pollutants such as NOₓ, SOₓ, CO₂, and various hydrocarbons into the atmosphere, such as would occur in a fossil fuel burning engine, such as a compression ignition engine (e.g., Diesel engine) or internal combustion engine (“ICE” e.g., gasoline powered engine such as an Otto cycle ICE and/or Atkinson cycle ICE).

FCEV 100 may be operated in various modes, also referred to as an operational status or condition. For example, FCEV 100 may operate in the following modes: off mode (supports lighting, safety features), accessory mode (body, chassis, safety, HVAC), remote run mode (remote start of the vehicle to thermally condition systems, including cabin), run mode (full operation), fueling mode (security, lighting, HVAC during fueling), service mode (all vehicle functionality and vehicle diagnostics data), autonomous mode (similar to run mode but autonomously controlled), drone mode (similar to run mode but control of vehicle is performed remote to the vehicle), and semi-autonomous mode (similar to autonomous mode but only certain controls are performed autonomously while others are configured to be performed by an operator). Fueling mode comprises a mode whereby hydrogen gas is conducted into hydrogen storage system 112. A fueling station may connect to hydrogen storage system 112 via one or more fluid connections. Further, a fueling station may comprise one or more wired or wireless interfaces that communicate data to and from FCEV 100 and the fueling station. Other fueling stations, however, do not have such data communication links. Defueling mode may comprise a mode whereby hydrogen gas is released from hydrogen storage system 112 and either fed to a fuel cell or vented to the ambient environment. Drive-ready mode or status comprises a mode wherein FCEV 100 remains stationary, but one or more power systems may be active and the FCEV 100 is ready to be driven. Drive-ready mode or status may be comparable to the “idle” state of a conventional fossil fuel burning vehicle. Drive mode comprises a state whereby FCEV 100 is in motion under its own power. One or more fuel cells may be functioning during drive mode, though drive mode also includes a state where FCEV 100 is traveling under battery stored power. Drive mode is thus characterized by current motion of the FCEV 100. Off mode comprises a mode where the FCEV 100 is stationary and awaiting to be put into another mode. Certain systems of FCEV 100 may be active, but FCEV 100 would typically be considered “off” in off mode. FCEV 100 may be operated during driving by a user onboard FCEV 100. However, in various embodiments, FCEV 100 may be operated remotely by a remote user in electronic communication with FCEV 100 to provide driving commands. In still further embodiments, FCEV 100 is operated autonomously through the use of self-driving logic and onboard sensors, such as cameras, LiDAR arrays, IR sensors, and other optical and audio input devices.

Park preparation condition comprises a state where FCEV 100 is preparing to enter park mode. Park preparation condition may occur in response to a command from a driver or remote operator to place FCEV 100 in park.

A low fuel cell power demand condition comprises a state where power demand from the fuel cell is relatively low. In various embodiments, a low fuel cell power demand condition may comprise a time or time period where power demand on the fuel cell is from 0.5%-20% maximum fuel cell power output capacity, and/or from 5%-15% maximum fuel cell power output capacity, and/or from 8%-12% maximum fuel cell power output capacity.

Similar to how a fossil fuel burning engine carries flammable petroleum products, FCEVs typically carry hydrogen gas. Like petroleum products, hydrogen gas is flammable. Thus, movement and storage of hydrogen gas should be carefully controlled and beneficially monitored accordingly. Moreover, hydrogen gas has a negative Joule-Thompson coefficient at temperatures typically associated with the Earth's surface (i.e., between −20° F. (−28° C.) and 120° F. (49° C.)). This means that hydrogen gas increases in temperature upon being moved into a tank and upon being expelled from a tank through an orifice. Depending upon ambient temperature and the velocity of the gas flowing through the orifice, this increase in temperature may create a hazardous condition. Thus, fueling and defueling a hydrogen gas tank may become hazardous if not properly controlled. Further, should the integrity of the tank become compromised, such as in the event of a fire or vehicular accident, the hydrogen gas stored therein should be vented to prevent or reduce the severity of a fire. These complexities of moving, storing, and using hydrogen gas on a vehicle have traditionally inhibited the adoption of FCEVs, which thus inhibit the conversion of fossil fuel burning vehicles to cleaner alternatives. In that regard, improved monitoring and management for hydrogen gas tanks on vehicles would be associated with improved environmental impact and safer roadways and fueling stations.

FCEVs may comprise more than one tank of hydrogen gas arranged in an array. The array may be managed as a system plumbed together to fuel and defuel as a unit. However, the tanks may experience varying conditions from one another during use, which may benefit from a tank-by-tank approach to management. In that regard, managing an array as a whole eases interactions with other onboard systems, while managing each tank in the array closely improves safety and performance. To facilitate management, temperature and pressure sensors may be employed to sense temperature and pressure. The ideal gas law, PV=nRT, relates P=pressure, V=volume, T=temperature, n=number of moles of a gas, and the R=ideal gas constant. The ideal gas law may be used as an approximation for the behavior of hydrogen gas, though of course real gases behave differently than an ideal gas. Thus, from the sensed pressure and temperatures, density of the gas stored therein may be derived. Density of hydrogen gas may be used to monitor for safety and, from the known tank volume, the mass of hydrogen stored, among other things.

Any physical property sensor, such as a temperature sensor or pressure sensor, may become unreliable over its lifetime. Such a sensor may become “noisy” meaning that the sensor displays wide variations in signal despite monitoring a steady state system. For example, given a steady state of pressure, a sensor that displays a 15% variance in pressure measurement in measurements taken 1 second apart may be considered “noisy.” Sensors may also fail over time and benefit from replacement. In that regard, vehicular systems should be robust enough to maintain functionality even with at least one pressure and/or temperature sensors having failed or becoming excessively noisy.

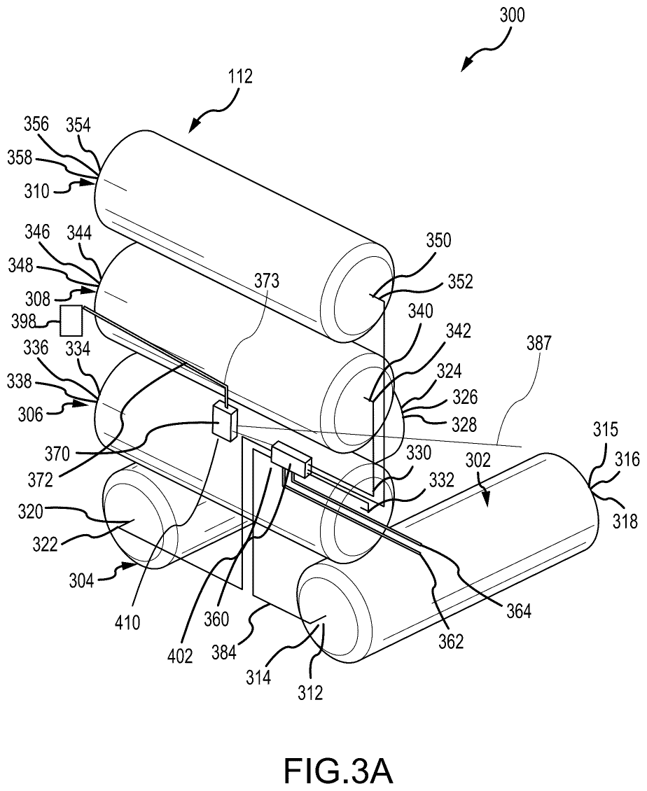

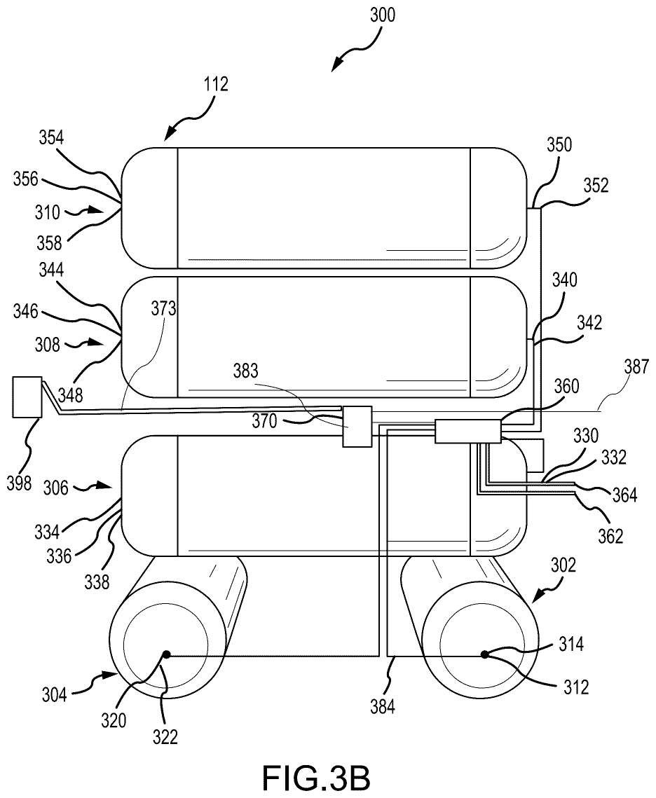

Referring now to FIGS. 3A and 3B, hydrogen storage system 112 is shown including valve diagnostic system 300. Valve diagnostic system 300 comprises various temperature and pressure sensors in electrical, wireless, and/or logical communication with controller 402 as well as various valves that are also in electrical, wireless, and/or logical communication controller 402.

Hydrogen storage system 112 receives hydrogen gas from input 362 and input 364. Hydrogen gas may be in compressed form. Hydrogen gas is received into manifold 360 and distributed to tanks 302, 304, 306, 308, and 310 via plumbing system 384.

Tanks 302, 304, 306, 308, and 310 comprise a plurality of type III or type IV pressurized vessels. Tanks 302, 304, 306, 308, and 310 may be positioned at the rear of cab 102 and/or on either side of chassis 104 between the frame rails of chassis 104 and side covers 108. In various embodiments, the tanks 302, 304, 306, 308, and 310 may be configured to contain pressurized gaseous or liquid hydrogen at a pressure of between approximately 350 bar (35 MPa) to 875 bar (87.5 MPa), or between approximately 500 (50 MPa) and 750 bar (75 MPa), or approximately 600 bar (60 MPa). In embodiments where liquid hydrogen is employed, the pressure may be between 2 bar (0.2 MPa) and 30 bar (3 MPa). As a result, tanks 302, 304, 306, 308, and 310 may be configured to deliver hydrogen along a downward pressure gradient to a fuel cell system without the need for one or more compressors that may otherwise consume electrical energy and adversely impact vehicle range. In various embodiments where liquid hydrogen is employed, an additional compressor may be employed to pressurize the hydrogen to suit the incoming pressure specifications of the fuel cell. In various embodiments, such as those utilizing liquid hydrogen storage, a heat exchanger may be employed to thermally condition the hydrogen to suit the incoming temperature specifications of the fuel cell.

Manifold 360 may fuel one or more of tanks 302, 304, 306, 308, and 310 in a selectable manner. Regulator 370 receives hydrogen gas from tanks 302, 304, 306, 308, and 310 via manifold 360 and plumbing system 384 and conducts hydrogen gas to a fuel cell. A fueling system may be in communication with controller 402 to facilitate hydrogen gas flow, though in various embodiments no such communication may occur. Tanks 302, 304, 306, 308, and 310 are illustrated having tanks 304 and 302 oriented perpendicular to tanks 306, 308, and 310, though other spatial configurations are contemplated herein. Vent system 387 is coupled to regulator 370. In various embodiments, additional lines fluidly coupled to each of tanks 302, 304, 306, 308, and 310 are configured with a mechanical switch to vent in the event of an emergency. Regulator 370, being in fluid communication with manifold 360 and thus each of tanks 302, 304, 306, 308, and 310, can experience pressure from hydrogen gas from all tanks. Regulator 370 may be equipped with a mechanical vent valve (vent valve 410) that is mechanically biased (e.g., biased by a spring) to the closed position. In the event the collective pressure from tanks 302, 304, 306, 308, and 310 overcomes the mechanical bias, regulator 370 may vent hydrogen gas to the ambient environment. Vent valve 410 thus fluidly couples the plumbing of vent system 387 with the ambient environment. In response to the hydrogen gas pressure from tanks 302, 304, 306, 308, and 310 falling below the mechanical bias force, regulator 370 may close the vent valve via the mechanical bias force. Vent system 387 thus fluidly couples hydrogen storage system 112 to the ambient environment. In the event that hydrogen storage system 112 would benefit from emptying hydrogen gas, vent system 387 may be activated in this manner to conduct hydrogen gas away from each of tanks 302, 304, 306, 308, and 310 into the ambient environment where the hydrogen gas may be less of a hazard in the event of over pressurization.

Hydrogen storage system 112 may comprise valves that are manually, electromechanically, hydraulically, and/or pneumatically actuated. In that regard, a valve assembly may comprise a valve and an electromechanical device that is in electrical, wireless, and/or logical communication with controller 402 such that controller 402 may issue commands to the electromechanical device to open, close, partially open, or partially close the valve. Various temperature and pressure measurements may be transmitted to controller 402 at various intervals. These intervals are selectable, and may be from 1 ms to 500 ms, from 1 ms to 1 s, and/or from 50 ms to 2 s.

Tank 302 comprises on tank valve (OTV) 312 that comprises OTV temperature sensor 314. OTV 312 receives hydrogen gas from plumbing system 384. End plug (EP) 315 comprises temperature sensor 316 and pressure sensor 318. Tank 304 comprises OTV 320 that further comprises OTV temperature sensor 322. EP 324 comprises temperature sensor 326 and pressure sensor 328. Tank 306 comprises OTV 330 that further comprises OTV temperature sensor 332. EP 334 comprises temperature sensor 336 and pressure sensor 338. Tank 308 comprises OTV 340 that further comprises OTV temperature sensor 342. EP 344 comprises temperature sensor 346 and pressure sensor 348. Tank 310 comprises OTV 350 that further comprises OTV temperature sensor 352. EP 354 comprises temperature sensor 356 and pressure sensor 358. In various embodiments, each OTV may further comprise a pressure sensor. In that regard, each of OTVs 312, 320, 330, 340, and 350 may comprise a pressure sensor.

It should be noted that OTV temperature sensors 314, 322, 332, 342, and 352 may not necessarily observe the same temperature observed by EP temperature sensors 316, 326, 336, 346, and 356 at the same time. As hydrogen gas enters or exits the tank, localized heat transfer, some of which is associated with compressing hydrogen gas or expanding hydrogen gas, may affect the localized temperatures observed at either end of the tank. In that regard, some difference in temperature readings between OTV temperature sensors 314, 322, 332, 342, and 352 and EP temperature sensors 316, 326, 336, 346, and 356 is expected, especially during non-steady state times, such as during fueling and/or defueling/discharge to the fuel cell system.

Regulator 370 is fluidly coupled to fuel cell supply line 373. In this manner, regulator 370 is able to regulate flow of hydrogen gas to fuel cell 398. Fuel cell 398, as discussed above, produces electrical energy from the hydrogen gas to power FCEV 100. As fuel cell 398 consumes hydrogen gas to produce electrical energy, should all tanks 302, 304, 306, 308, and 310 be in a closed position, and thus not sending additional hydrogen gas flow to regulator 370, the pressure in fuel cell supply line 373, manifold 360, and/or plumbing system 384, will decrease as hydrogen gas is consumed but not replenished from tanks 302, 304, 306, 308, and 310. Opening any of OTVs 312, 320, 330, 340, and 350 will allow flow of hydrogen gas into fuel cell supply line 373, manifold 360, and/or plumbing system 384 and thus raise the pressure inside these components. Regulator 370 comprises one or more pressure sensors 383 capable of measuring the pressure of fuel cell supply line 373, manifold 360, and/or plumbing system 384.

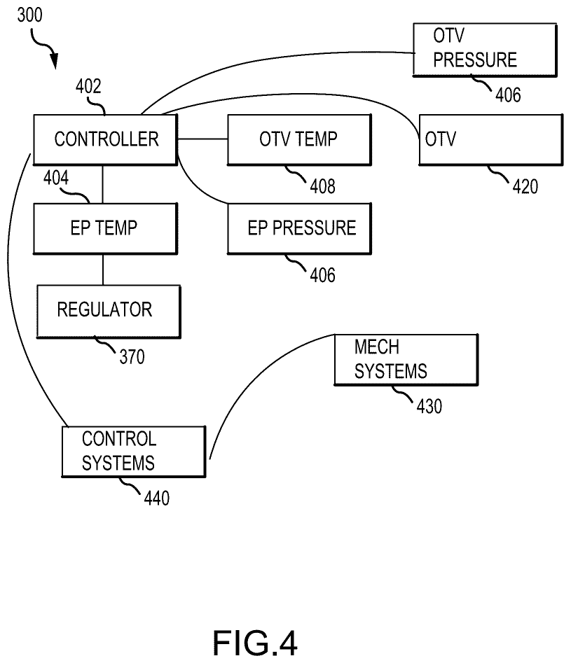

With reference to FIG. 4, valve diagnostic system 300 is illustrated schematically. Controller 402 comprises a processor or other hardware that is capable of executing instructions, as further described herein. Controller 402 is in electrical, wireless, and/or logical communication with OTV array 420. OTV array 420 comprises the OTVs of hydrogen storage system 112, namely, OTVs 312, 320, 330, 340, and 350. As described above, OTVs 312, 320, 330, 340, and 350 each comprise an electronically actuated valve in fluid communication with each of tanks 302, 304, 306, 308, and 310, and manifold 360. In that regard, OTVs 312, 320, 330, 340, and 350 may selectively open and close electronically actuated valves and cause each of tanks 302, 304, 306, 308, and 310 to be in fluid communication with manifold 360 (i.e., open electronically actuated valve) or to be fluidly isolated from manifold 360 (i.e., closed electronically actuated valve). Controller 402 is in electrical, wireless, and/or logical communication with regulator 370 and pressure sensor 383. In this manner, controller 402 may receive a pressure from regulator 370 that is indicative of the pressure in fuel cell supply line 373 and/or at manifold 360.

Controller 402 is in electrical, wireless, and/or logical communication with OTV temperature sensor array 408 (OTV temperature sensors 314, 322, 332, 342, and 352), EP pressure sensor array 406 (EP pressure sensors 318, 328, 338, 348, and 358), and EP temperature sensor array 404 (EP temperature sensors 316, 326, 336, 346, and 356). In various embodiments, controller 402 is in electrical, wireless, and/or logical communication with OTV pressure sensor array 406. OTV pressure sensor array 406 comprises the array of OTV pressure sensors associated with each of OTVs 312, 320, 330, 340, and 350, in various embodiments. Controller 402 is in electronic communication with control systems 440. Control systems 440 may include other controllers, processors, and other electronic devices that control aspects of various systems on FCEV 100. Control systems 440 may exist onboard FCEV 100 or may be remote from FCEV 100. Control systems 440 are in electronic communication and/or mechanical communication with mechanical systems 430. Mechanical systems 430 of FCEV 100 implement various driving functions, such as the braking system, the parking brake, the electric motor(s), onboard lights, onboard displays, and other similar systems.

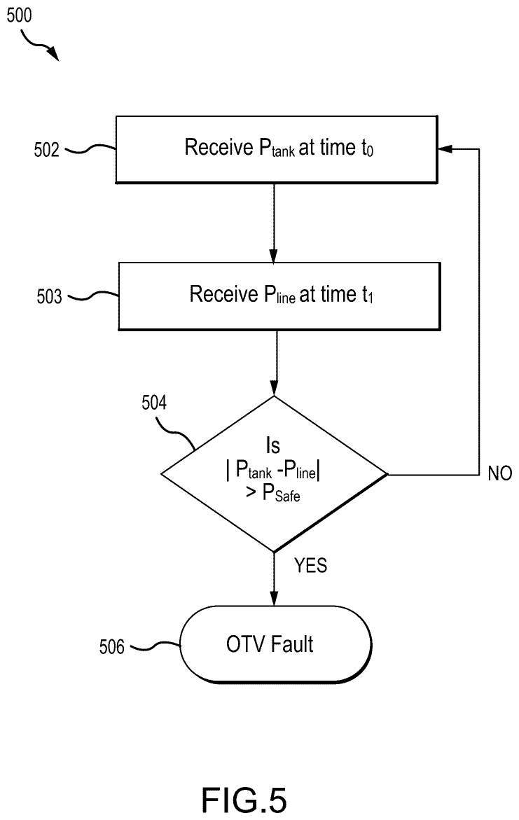

With reference to FIG. 5, valve diagnostic 500 is illustrated. Controller 402 may determine if several conditions are present prior to proceeding with valve diagnostic 500. Valve diagnostic 500 is run at least partially during a time when fuel cell 398 is consuming hydrogen gas, for example, during drive mode. As described herein, should a high output demand exist for fuel cell 398, it may not be prudent to conduct valve diagnostics, as diagnostics may include closing one or more OTVs 312, 320, 330, 340, and 350, which could be detrimental to fuel cell 398 output. Too little demand on fuel cell 398, however, would mean that hydrogen consumption would occur at too low a rate to reliably measure a pressure reduction at manifold 360. In that regard, there is a relative zone of fuel cell 398 hydrogen consumption that balances output performance with enough output to produce reliable results.

Controller 402 may verify that at least one of tanks 302, 304, 306, 308, and 310 has an internal pressure above a threshold pressure. In various embodiments, the threshold pressure may be at least 10 bar, at least 30 bar, at least 50 bar, or any other suitable threshold pressure. In various embodiments, controller 402 may additionally or alternatively verify that at least one of tanks 302, 304, 306, 308, and 310 has an internal temperature above a threshold temperature. In various embodiments, the threshold temperature may be at least 5° C., at least 10° C., at least 20° C., or any other suitable threshold temperature. Controller 402 may also determine the duty cycle of OTVs 312, 320, 330, 340, and 350. In various embodiments, the duty cycle of OTVs 312, 320, 330, 340, and 350 may refer to an open/close cycle of one or more of OTVs 312, 320, 330, 340, and 350 and/or a time and/or distance between increments of valve diagnostic 500. For example, in some exemplary embodiments, the duty cycle may be less than 1 diagnostic per 50 miles driven, less than 1 diagnostic per 100 miles driven, less than 1 diagnostic per 200 miles driven, or other suitable increment.

At receive Pₜₐₙₖ 502, valve diagnostic system 300 monitors pressure in at least one of tanks 302, 304, 306, 308, and 310. During receive Pₜₐₙₖ 502, an OTV pressure sensor associated with one of OTVs 312, 320, 330, 340, and 350 and/or an EP pressure sensor associated with one of EPs 315, 324, 334, 344, 354, measures Pₜₐₙₖ, which is the pressure inside one of tanks 302, 304, 306, 308, and 310.

Pₜₐₙₖ is taken at time to. After a predetermined time interval, receive Pₗᵢₙₑ 503 occurs. At receive Pₗᵢₙₑ 503, pressure sensor 383 associated with regulator 370 takes the pressure inside manifold 360, fuel cell supply line 373 and/or at regulator 370 at time t₁. In various embodiments, the predetermined time interval may be determined, in part, based on a pressure and/or temperature inside one or more of tanks 302, 304, 306, 308, and 310 at time t₀ . In various embodiments, the predetermined time interval may be based on an average or nominal pressure and/or temperature in tanks 302, 304, 306, 308, and 310 at time t₀ . The predetermined time interval may increase as the pressure or average or nominal pressure in tanks 302, 304, 306, 308, and 310 decreases. In other words, when the pressure in tanks 302, 304, 306, 308, and 310 is relatively high, it is expected that the time between time t₀ and time t₁ will be less than when the pressure in tanks 302, 304, 306, 308, and 310 is relatively low. In various embodiments, a lookup table of the predetermined time intervals for each pressure and/or temperature value for each tank, or an average pressure and/or temperature value for all tanks, may be stored in memory in controller 402 or other internal or external controller.

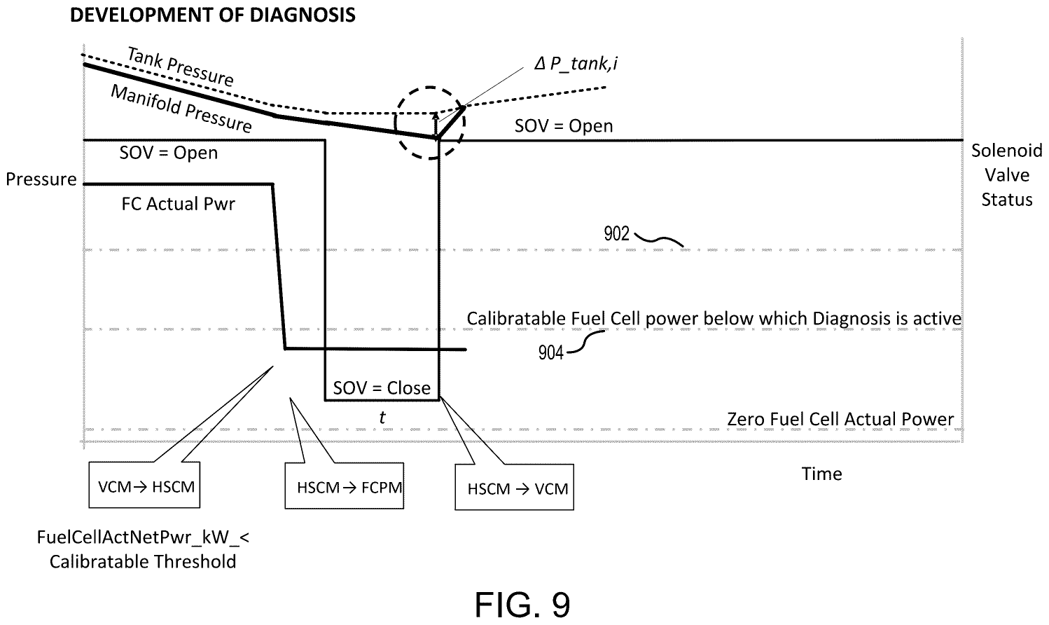

Time t₁ occurs later in time than t₀. The greater the time between time t₁ and time to, the greater the pressure difference is expected to be observed for a given constant rate of hydrogen consumption by the fuel cell 398. Stated another way, the longer the time interval, the more hydrogen fuel cell 398 will consume which means the more the pressure of hydrogen gas will decrease. With brief reference to FIG. 9, hydrogen pressure at manifold 360 is illustrated over time. As shown, the OTV open, the pressure at manifold 360 and the tank pressure will be substantially similar. As the OTV closes, the pressure in manifold 360 drops as a function of fuel cell 398 hydrogen consumption. Pressure 902 represents a level of pressure above which is useful for diagnostic purposes. Stated another way, pressures above pressure 902 are able to be resolved to show a meaningful difference in pressure without leaving a large margin of error. Level 904 represents a level of fuel cell power consumption below which the diagnostic is useful. Stated another way, the fuel cell 398 should have a power demand below level 804 to ensure accurate measurements but without impairing hydrogen gas flow in a manner that would be detrimental to the operation of fuel cell 398 and/or vehicle 100 (e.g., times of high power demand). As such, in various embodiments, valve diagnostic 500 may further comprise closing one or more of OTVs 312, 320, 330, 340, and 350 prior to receive Pₗᵢₙₑ at time t₁.

With reference back to FIG. 5, at comparison 504, if the absolute value of the difference of Pₜₐₙₖ and Pₗᵢₙₑ is less than P_{Safe} , then OTV fault 506 occurs. P_{Safe} represents a threshold establishing when there may be too small an amount of difference between Pₜₐₙₖ and Pₗᵢₙₑ based on an expected difference between Pₜₐₙₖ and Pₗᵢₙₑ. Stated another way, this situation would mean that the pressure in fuel cell supply line 373, manifold 360, and/or plumbing system 384 would not have decreased substantially with respect to the pressure in at least one of tanks 302, 304, 306, 308, and 310, which would be indicative of an OTV valve being stuck in the open or partially open position. OTV fault 506 may comprise sending an OTV stuck open fault to a controller area network (CAN) bus or other component onboard FCEV 100 and/or a remote monitoring system associated with FCEV 100.

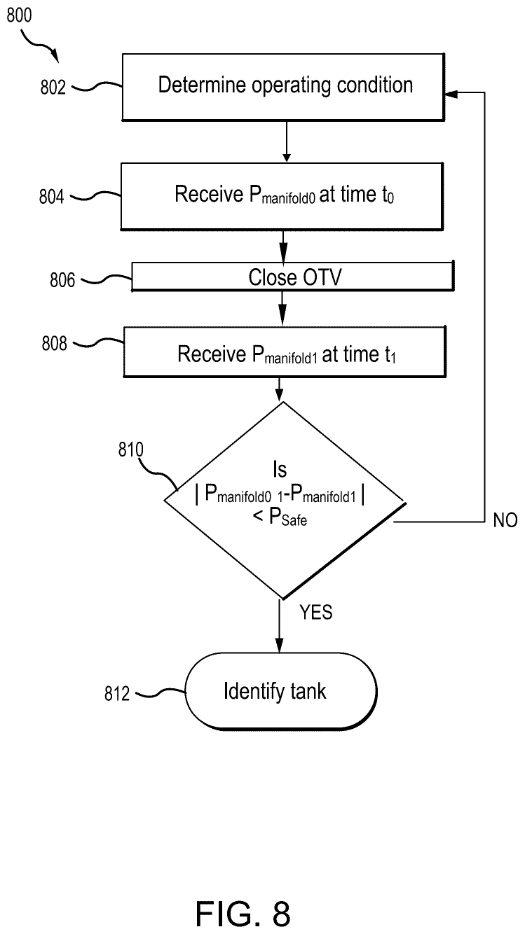

With reference to FIG. 8, valve diagnostic 800 is illustrated. Controller 402 may determine if several conditions are present prior to proceeding with valve diagnostic 500. Valve diagnostic 500 is run at least partially during a time when fuel cell 398 is consuming hydrogen gas, for example, during drive mode. As described herein, should a high output demand exist for fuel cell 398, it may not be prudent to conduct valve diagnostics, as diagnostics may include closing one or more OTVs 312, 320, 330, 340, and 350, which could be detrimental to fuel cell 398 output. Too little demand on fuel cell 398, however, would mean that hydrogen consumption would occur at too low a rate to reliably measure a pressure reduction at manifold 360. In that regard, there is a relative zone of fuel cell 398 hydrogen consumption that balances output performance with enough output to produce reliable results.

In step 802, controller 402 may determine the operating mode and/or operating condition. In drive mode, autonomous mode, and/or semi-autonomous mode, among others, it is known that the OTVs 312, 320, 330, 340, and 350 will be open, supplying hydrogen gas to fuel cell supply line 373, manifold 360, and/or plumbing system 384. Controller 402 may also determine the duty cycle of OTVs 312, 320, 330, 340, and 350. In various embodiments, the duty cycle of OTVs 312, 320, 330, 340, and 350 may refer to an open/close cycle of one or more of OTVs 312, 320, 330, 340, and 350 and/or a time and/or distance between increments of valve diagnostic 800. For example, in some exemplary embodiments, the duty cycle may be less than 1 diagnostic per 50 miles driven, less than 1 diagnostic per 100 miles driven, less than 1 diagnostic per 200 miles driven, or other suitable increment. In various embodiments, in step 802, controller may receive and/or determine a fuel cell power output to identify a desirable and/or suitable window in which to perform valve diagnostic 800.

At receive P_{manifold0} 804, valve diagnostic system 800 monitors pressure in at least one of fuel cell supply line 373, manifold 360, and/or plumbing system 384. P_{manifold0} is received at controller 402 from a sensor in regulator 370 that is configured to measure the pressure in at least one of fuel cell supply line 373, manifold 360, and/or plumbing system 384. In this manner, P_{manifold0} is taken at time t₀ .

At close OTV 806, controller 402 commands OTVs 312, 320, 330, 340, and 350 to close. In this manner, pressure from hydrogen gas inside OTVs 312, 320, 330, 340, and 350 is fluidically prevented from flowing into fuel cell supply line 373, manifold 360, and/or plumbing system 384. Thus, fuel cell 398 continues to draw hydrogen from fuel cell supply line 373, manifold 360, and/or plumbing system 384 but the supply of hydrogen gas is not replenished from the hydrogen gas stored in tanks 302, 304, 306, 308, and 310. Thus, it is expected that the pressure in fuel cell supply line 373, manifold 360, and/or plumbing system 384 will decrease over time after OTVs 312, 320, 330, 340, and 350 are closed.

After OTVs 312, 320, 330, 340, and 350 are closed in close OTV 806, receive P_{manifold1} 808 occurs. P_{manifold1} is received at controller 402 from a sensor in regulator 370 that is configured to measure the pressure in at least one of fuel cell supply line 373, manifold 360, and/or plumbing system 384. For the avoidance of doubt, both P_{manifold0} and P_{manifold1} represent pressure in at least one of fuel cell supply line 373, manifold 360, and/or plumbing system 384, though whichever component is measured for P_{manifold0} is also measured for P_{manifold1}. For example, if P_{manifold0} represents pressure in the manifold 360, P_{manifold1} also represents pressure in manifold 360.

P_{manifold1} is taken at time t₁. Time t₁ is after time t₀ . The difference between t₁ and to (also referred to as Δt) may be between 1 ms-10s, 500 ms-5s and/or between 1s and 4s. The greater the time between time t₁ and time t₀, the greater the pressure difference is expected to be observed for a given constant rate of hydrogen consumption by the fuel cell 398. Stated another way, the longer the time interval, the more hydrogen fuel cell 398 will consume which means the more the pressure of hydrogen gas will decrease. In various embodiments, the time difference between t₁ and t₀ (or Δt) may be predetermined and based on, in part, a pressure and/or temperature inside one or more of tanks 302, 304, 306, 308, and 310, in fuel cell supply line 373, in manifold 360, and/or in plumbing system 384 at time t₀. In various embodiments, the predetermined time interval may be based on an average or nominal pressure and/or temperature in tanks 302, 304, 306, 308, and 310 at time t₀. The predetermined time interval may increase as the pressure or average or nominal pressure in tanks 302, 304, 306, 308, and 310 decreases. In other words, when the pressure in tanks 302, 304, 306, 308, and 310 is relatively high, it is expected that the time between time t₀ and time t₁ will be less than when the pressure in tanks 302, 304, 306, 308, and 310 is relatively low. In various embodiments, a lookup table of the predetermined time intervals for each pressure and/or temperature value for each tank, or an average pressure and/or temperature value for all tanks, may be stored in memory in controller 402 or other internal or external controller.

At comparison 810, the absolute value of the difference of P_{manifold0} and P_{manifold1} is determined. If the difference of P_{manifold0} and P_{manifold1} is less than P_{Safe}, identify tank process 812 occurs. P_{Safe} represents a threshold under which there is too little difference between P_{manifold0} and P_{manifold1} based on an expected difference between P_{manifold0} and P_{manifold1}. Stated another way, this situation would mean that the pressure in fuel cell supply line 373, manifold 360, and/or plumbing system 384 would not have decreased sufficiently with respect to the pressure in at least one of fuel cell supply line 373, manifold 360, and/or plumbing system 384, which would be indicative of an OTV valve being stuck in the open or partially open position. In addition to identify tank process 812, an OTV fault may occur that can comprise sending an OTV stuck open fault to a CAN bus or other component onboard FCEV 100 and/or a remote monitoring system associated with FCEV 100. An OTV fault may trigger an OTV stuck valve identification process to identify which OTV valve is stuck open.

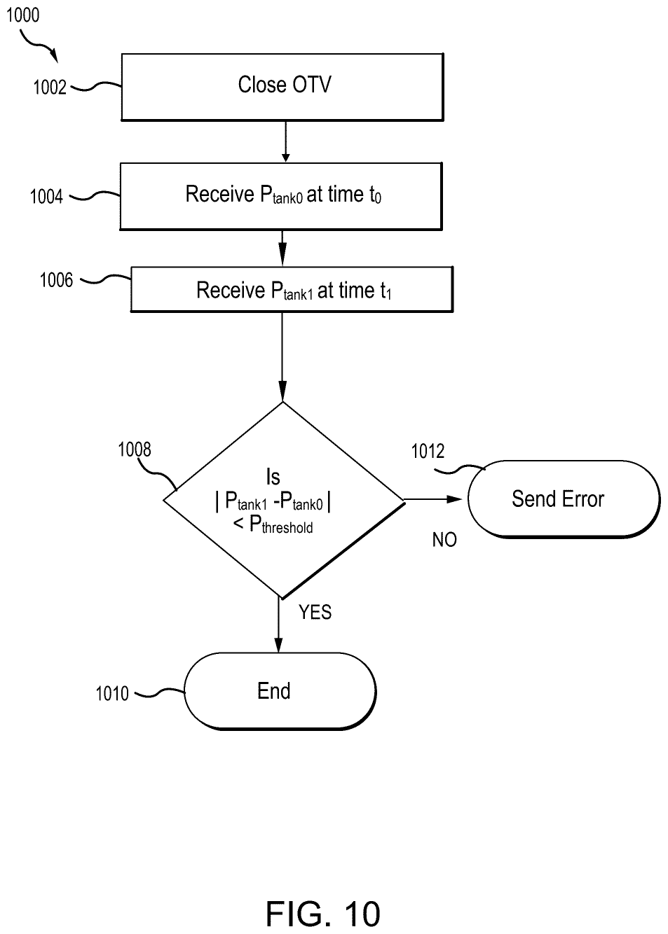

With reference to FIG. 10, OTV stuck valve identification process 1000 is illustrated. As discussed above, EP pressure sensors 318, 328, 338, 348, and 358 in EP pressure sensor array 406 sense pressure in tanks 302, 304, 306, 308, and 310, respectively. At close OTV 1002, controller 402 commands OTVs 312, 320, 330, 340, and 350 to close. In the alternative, at close OTV 1002, controller 402 may confirm that OTVs 312, 320, 330, 340, and 350 are in the closed state by referencing a data table or other data construct in a memory to verify that OTVs 312, 320, 330, 340, and 350 are closed.

At receive Pₜₐₙₖ₀ 1004, controller 402 receives a pressure for each of tanks 302, 304, 306, 308, and 310 from EP pressure sensors 318, 328, 338, 348, and 358, respectively. In this manner, a Pₜₐₙₖ₀ is obtained for each of tanks 302, 304, 306, 308, and 310.

t₁ occurs after a predetermined period of time has elapsed from t₀. The difference between t₁ and t₀ (also referred to as Δt) may be between 1 ms-10 s, 500 ms-5 s and/or between 1 s and 4 s. In various embodiments, similar to the discussion above, Δt may be a predetermined time interval based on one or more conditions of the hydrogen storage system, for example, a pressure or temperature associated with each of tanks 302, 304, 306, 308, and 310 at time t₀. Responsive to reaching time t₁, receive Pₜₐₙₖ₁ 1006 occurs and controller 402 receives a pressure for each of tanks 302, 304, 306, 308, and 310 from EP pressure sensors 318, 328, 338, 348, and 358, respectively. In this manner, a Pₜₐₙₖ₁ is obtained for each of tanks 302, 304, 306, 308, and 310.

Given that OTVs 312, 320, 330, 340, and 350 should be closed, Pₜₐₙₖ₀ and Pₜₐₙₖ₁ should not be appreciably different. In that regard, at process 1008, Pₜₐₙₖ₀ is subtracted from Pₜₐₙₖ₁ and the absolute value is taken. Then, the absolute value is compared to P_{threshold} which is a value of acceptable deviation between Pₜₐₙₖ₀ and Pₜₐₙₖ₁. In various embodiments, P_{threshold} may be approximately 5 bar, approximately 10 bar, approximately 15 bar, or another suitable pressure deviation.

If process 1008 returns true, then end 1010 occurs. Process 1008 proceeds to each Pₜₐₙₖ₀ and Pₜₐₙₖ₁ value per each of tanks 302, 304, 306, 308, and 310. In this regard, each of tanks 302, 304, 306, 308, and 310 is assessed. In various embodiments, each tank may be assessed at the same time or may be assessed in a staggering fashion. If process 1008 returns false, then send error 1012 occurs. Send error 1012 may comprise controller 402 sending an error message, for example one containing the tank that has the stuck open OTV valve, to a CAN bus or other component onboard FCEV 100 and/or a remote monitoring system associated with FCEV 100. An OTV fault may trigger further processing by FCEV 100 to ensure safety.

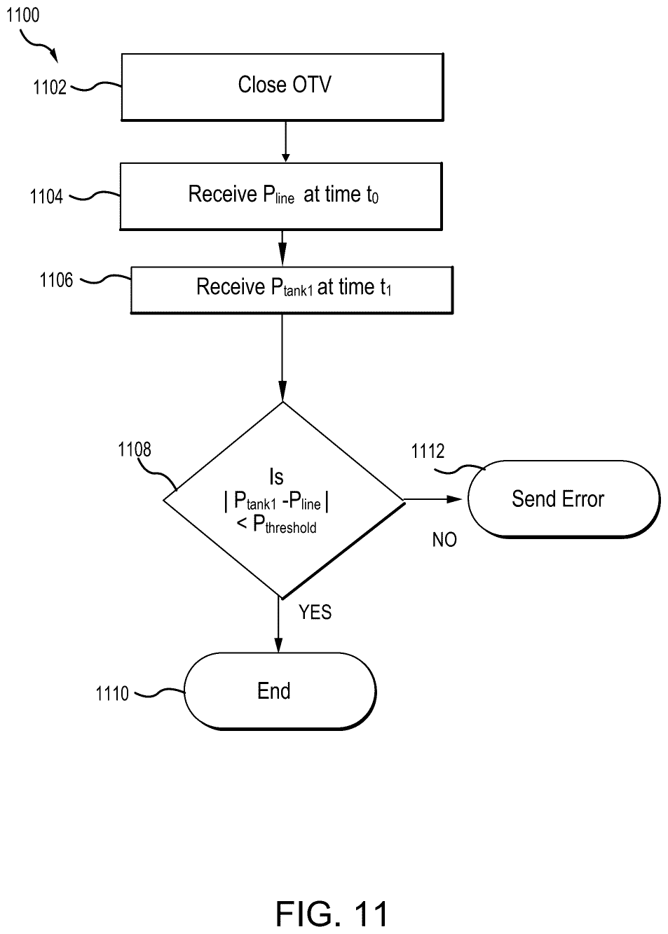

With reference to FIG. 11, OTV stuck valve identification process 1100 is illustrated. As discussed above, EP pressure sensors 318, 328, 338, 348, and 358 in EP pressure sensor array 406 sense pressure in tanks 302, 304, 306, 308, and 310, respectively. At close OTV 1102, controller 402 commands OTVs 312, 320, 330, 340, and 350 to close. In the alternative, at close OTV 1002, controller 402 may confirm that OTVs 312, 320, 330, 340, and 350 are in the closed state by referencing a data table or other data construct in a memory to verify that OTVs 312, 320, 330, 340, and 350 are closed. Fuel cell 398 may be operational, thus consuming hydrogen gas.

At receive Pₗᵢₙₑ 1104, controller 402 receives a pressure representative of at least one of fuel cell supply line 373, manifold 360, and/or plumbing system 384 at time t₀.

At receive Pₜₐₙₖ₁ at time t₁ 1106, controller 402 receives a pressure for each of tanks 302, 304, 306, 308, and 310 from EP pressure sensors 318, 328, 338, 348, and 358, respectively. In this manner, a Pₜₐₙₖ₁ is obtained for each of tanks 302, 304, 306, 308, and 310 at time t₁.

t₁ occurs after a predetermined period of time has elapsed from t₀. The difference between t₁ and t₀ (also referred to as Δt) may be between 1ms-10 s, 500 ms-5 s and/or between 1 s and 4 s. In various embodiments, similar to the discussion above, Δt may be a predetermined time interval based on one or more conditions of the hydrogen storage system, for example, a pressure or temperature associated with each of tanks 302, 304, 306, 308, and 310 at time t₀. Responsive to reaching time t₁, receive Pₜₐₙₖ₁ at time t₁ 1106 occurs and controller 402 receives a pressure for each of tanks 302, 304, 306, 308, and 310 from EP pressure sensors 318, 328, 338, 348, and 358, respectively. In this manner, a Pₜₐₙₖ₁ is obtained for each of tanks 302, 304, 306, 308, and 310.

Given that OTVs 312, 320, 330, 340, and 350 should be closed, Pₗᵢₙₑ should be less than Pₜₐₙₖ₁ as hydrogen gas is consumed in at least one of fuel cell supply line 373, manifold 360, and/or plumbing system 384 during Δt while Pₜₐₙₖ₁ should be greater if the tank is closed and no hydrogen gas is escaping. In that regard, at process 1108, Pₜₐₙₖ₁ is subtracted from Pₗᵢₙₑ and the absolute value is taken. Then, the absolute value is compared to P_{threshold} which is a value of minimum acceptable deviation between Pₗᵢₙₑ and Pₜₐₙₖ₁. In various embodiments, P_{threshold} may be approximately 5 bar, approximately 10 bar, approximately 15 bar, or another suitable pressure deviation.

If process 1108 returns true, then end 1110 occurs. Process 1108 proceeds to each Pₗᵢₙₑ and Pₜₐₙₖ₁ value per each of tanks 302, 304, 306, 308, and 310. In this regard, each of tanks 302, 304, 306, 308, and 310 is assessed. In various embodiments, each tank may be assessed at the same time or may be assessed in a staggering fashion. If process 1108 returns false, then send error 1112 occurs. Send error 1112 may comprise controller 402 sending an error message, for example one containing the tank that has the stuck open OTV valve, to a CAN bus or other component onboard FCEV 100 and/or a remote monitoring system associated with FCEV 100. An OTV fault may trigger further processing by FCEV 100 to ensure safety.

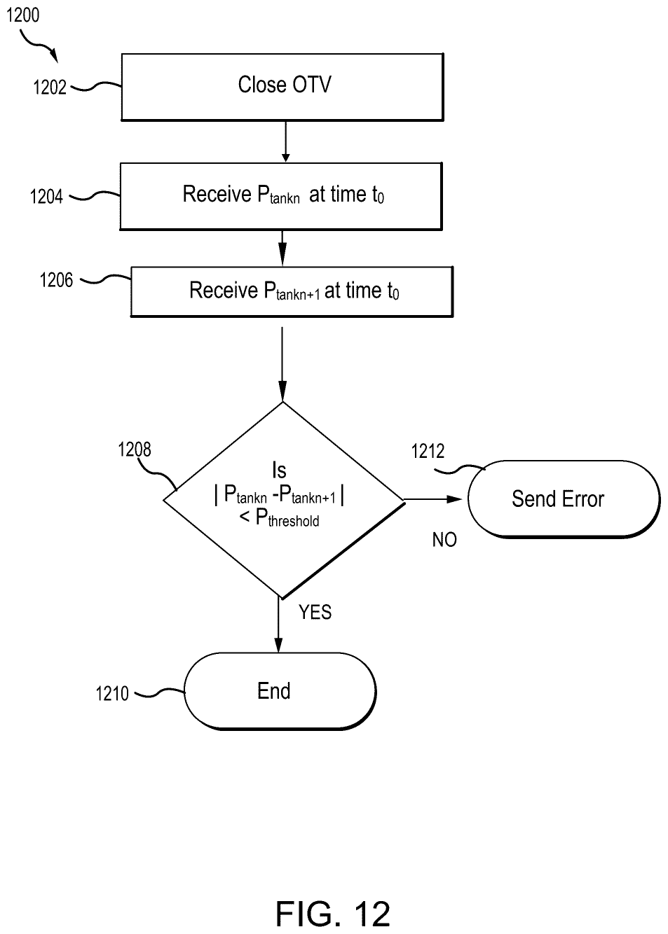

With reference to FIG. 12, OTV stuck valve identification process 1200 is illustrated. As discussed above, EP pressure sensors 318, 328, 338, 348, and 358 in EP pressure sensor array 406 sense pressure in tanks 302, 304, 306, 308, and 310, respectively. At close OTV 1202, controller 402 commands OTVs 312, 320, 330, 340, and 350 to close. In the alternative, at close OTV 1202, controller 402 may confirm that OTVs 312, 320, 330, 340, and 350 are in the closed state by referencing a data table or other data construct in a memory to verify that OTVs 312, 320, 330, 340, and 350 are closed. Fuel cell 398 may be operational, thus consuming hydrogen gas.

At receive Pₜₐₙₖₙ 1204, controller 402 receives a pressure representative of at least one of tanks 302, 304, 306, 308, and 310 (referred to here are “tank n”) at time t₀. At receive Pₜₐₙₖₙ₊₁ at time t₀ 1206, controller 402 receives a pressure for one of tanks 302, 304, 306, 308, and 310 that was not sampled in receive Pₜₐₙₖₙ 1204 (i.e., not the pressure from tank n) from EP pressure sensors 318, 328, 338, 348, and 358, respectively. In this manner, a Pₜₐₙₖₙ₊₁ is obtained for one of tanks 302, 304, 306, 308, and 310 at time t₀. to represents the same time point or substantially the same time point, where the term “substantially” in this context only refers to +/−2 ms.

Given that OTVs 312, 320, 330, 340, and 350 should be closed, Pₜₐₙₖₙ and Pₜₐₙₖₙ₊₁ should be substantially similar (i.e., the absolute value of the difference in pressures being less than a given threshold). However, should one of the OTVs on tank n or tank n+1 be stuck open, the absolute value of the difference in pressures would be greater than a given threshold. In that regard, at process 1208, Pₜₐₙₖₙ is subtracted from Pₜₐₙₖₙ₊₁ and the absolute value is taken.

Then, the absolute value is compared to P_{threshold} which is a value of minimum acceptable deviation between Pₜₐₙₖₙ and Pₜₐₙₖₙ₊₁. In various embodiments, P_{threshold} may be approximately 5 bar, approximately 10 bar, approximately 15 bar, or another suitable pressure deviation.

If process 1208 returns true, then end 1210 occurs. Process 1208 proceeds to each Pₜₐₙₖₙ and Pₜₐₙₖₙ₊₁ value per each of tanks 302, 304, 306, 308, and 310 using different combinations such that at each iteration, every one of tanks 302, 304, 306, 308, and 310 serves as tank n. In this regard, each of tanks 302, 304, 306, 308, and 310 is assessed. In various embodiments, each tank may be assessed at the same time or may be assessed in a staggering fashion. If process 1208 returns false, then send error 1212 occurs. Send error 1212 may comprise controller 402 sending an error message, for example one containing the tank that has the stuck open OTV valve, to a CAN bus or other component onboard FCEV 100 and/or a remote monitoring system associated with FCEV 100. An OTV fault may trigger further processing by FCEV 100 to ensure safety.

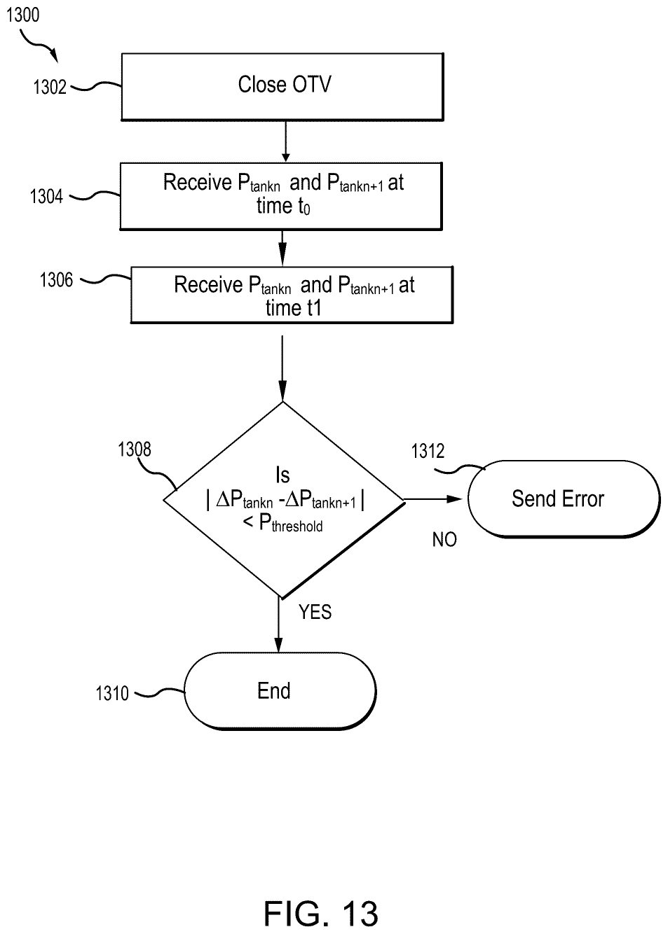

With reference to FIG. 13, OTV stuck valve identification process 1300 is illustrated. As discussed above, EP pressure sensors 318, 328, 338, 348, and 358 in EP pressure sensor array 406 sense pressure in tanks 302, 304, 306, 308, and 310, respectively. At close OTV 1302, controller 402 commands OTVs 312, 320, 330, 340, and 350 to close. In the alternative, at close OTV 1302, controller 402 may confirm that OTVs 312, 320, 330, 340, and 350 are in the closed state by referencing a data table or other data construct in a memory to verify that OTVs 312, 320, 330, 340, and 350 are closed. Fuel cell 398 may be operational, thus consuming hydrogen gas.

At receive Pₜₐₙₖₙ and Pₜₐₙₖₙ₊₁ at time t₀ 1304, controller 402 receives a pressure representative of at least one of tanks 302, 304, 306, 308, and 310 (referred to here are “tank n”) at time t₀ and a pressure for one of tanks 302, 304, 306, 308, and 310 (referred to here are “tank n+1”) that is not tank n from EP pressure sensors 318, 328, 338, 348, and 358 at time t₀, respectively. In this manner, a Pₜₐₙₖₙ₊₁ is obtained for two of tanks 302, 304, 306, 308, and 310 at time t₀.

At receive Pₜₐₙₖₙ and Pₜₐₙₖₙ₊₁ at time t₁ 1306, controller 402 receives a pressure representative of at least one of tanks 302, 304, 306, 308, and 310 (referred to here are “tank n”) at time t₁ and a pressure for one of tanks 302, 304, 306, 308, and 310 (referred to here are “tank n+1”) that is not tank n from EP pressure sensors 318, 328, 338, 348, and 358 at time t₁, respectively. In this manner, a Pₜₐₙₖₙ and Pₜₐₙₖₙ₊₁ is obtained for two of tanks 302, 304, 306, 308, and 310 at time t₁.

t₁ occurs after a predetermined period of time has elapsed from t₀. The difference between t₁ and to (also referred to as Δt) may be between 1 ms-10 s, 500 ms-5 s and/or between 1 s and 4 s. In various embodiments, similar to the discussion above, Δt may be a predetermined time interval based on one or more conditions of the hydrogen storage system, for example, a pressure or temperature associated with each of tanks 302, 304, 306, 308, and 310 at time t₀. Responsive to reaching time t₁, receive Pₜₐₙₖₙ and Pₜₐₙₖₙ₊₁ at time t₁ 1306 occurs and controller 402 receives a pressure for tank n and tank n+1 in tanks 302, 304, 306, 308, and 310 from EP pressure sensors 318, 328, 338, 348, and 358, respectively.

A change in Pₜₐₙₖₙ may be calculated by subtracting Pₜₐₙₖₙ at time t₀ from Pₜₐₙₖₙ at time t₁ to yield ΔPₜₐₙₖₙ. A change in Pₜₐₙₖₙ₊₁ may be calculated by subtracting Pₜₐₙₖₙ₊₁ at time t₀ from Pₜₐₙₖₙ₊₁ at time t₁ to yield ΔPₜₐₙₖₙ₊₁. ΔPₜₐₙₖₙ₊₁ and ΔPₜₐₙₖₙ may include the absolute value of the subtraction operation.

Given that OTVs 312, 320, 330, 340, and 350 should be closed, Pₜₐₙₖₙ and Pₜₐₙₖₙ₊₁ should be substantially similar (i.e., the absolute value of the difference in pressures being less than a given threshold) over Δt. However, should one of the OTVs on tank n or tank n+1 be stuck open, the absolute value of the change in pressures over Δt would be greater than a given threshold. In that regard, at process 1308, ΔPₜₐₙₖₙ is subtracted from ΔPₜₐₙₖₙ₊₁ and the absolute value is taken. Then, the absolute value is compared to P_{threshold} which is a value of minimum acceptable deviation between ΔPₜₐₙₖₙ and ΔPₜₐₙₖₙ₊₁. In various embodiments, P_{threshold} may be approximately 5 bar, approximately 10 bar, approximately 15 bar, or another suitable pressure deviation.

If process 1308 returns true, then end 1310 occurs. Process 1308 proceeds to each Pₜₐₙₖₙ and Pₜₐₙₖₙ₊₁ value per each of tanks 302, 304, 306, 308, and 310 using different combinations such that at each iteration, every one of tanks 302, 304, 306, 308, and 310 serves as tank n. In this regard, each of tanks 302, 304, 306, 308, and 310 is assessed. In various embodiments, each tank may be assessed at the same time or may be assessed in a staggering fashion. If process 1308 returns false, then send error 1312 occurs. Send error 1312 may comprise controller 402 sending an error message, for example one containing the tank that has the stuck open OTV valve, to a CAN bus or other component onboard FCEV 100 and/or a remote monitoring system associated with FCEV 100. An OTV fault may trigger further processing by FCEV 100 to ensure safety.

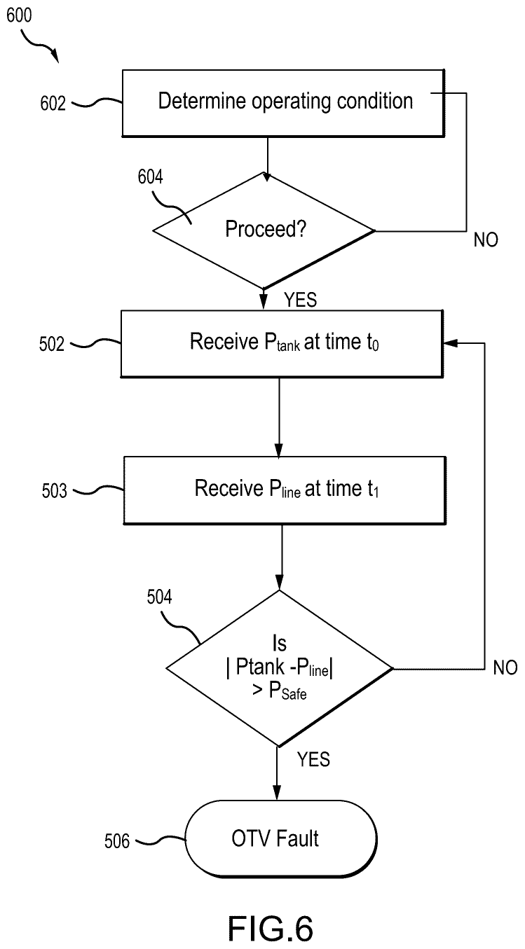

With reference to FIG. 6, valve diagnostic 600 is illustrated. Valve diagnostic 600 contains several components of valve diagnostic 500, which is discussed above. At determine operating condition 602, the operating condition of FCEV 100 is ascertained. In various embodiments, the operating condition may be ascertained by controller 402 or communicated to controller 402 by another internal or external controller, for example, a vehicle control module (VCM) or other suitable controller. As discussed above, FCEV 100 may assume a variety of operating conditions. Valve diagnostic 600 may be suitable for use in one or more of a driving condition, a park preparation condition, or a fuel cell power demand condition, as described above. In some embodiments, valve diagnostic 600 may be suitable for use in one or more of a fuel cell power ramp down condition or a coasting condition. Performing in these operating conditions may be unobtrusive to the driving experience and does not require the fuel cell to be powered on solely for the purposes of diagnostics (e.g., at vehicle startup), which is wasteful of hydrogen gas. Moreover, during park preparation and low fuel cell power demand conditions, OTVs 312, 320, 330, 340, and 350 are known to be open and thus able to be tested by processes, such as those set forth in various embodiments, that involve the closing of OTVs 312, 320, 330, 340, and 350. Continuing to proceed 604, if the operating condition is at least one of a driving condition, a park preparation condition, or a fuel cell power demand condition, receive Pₜₐₙₖ 502 occurs. If the operating condition is not any of a driving condition, a park preparation condition, or a fuel cell power demand condition, determine operating condition 602 may occur again at a later time.

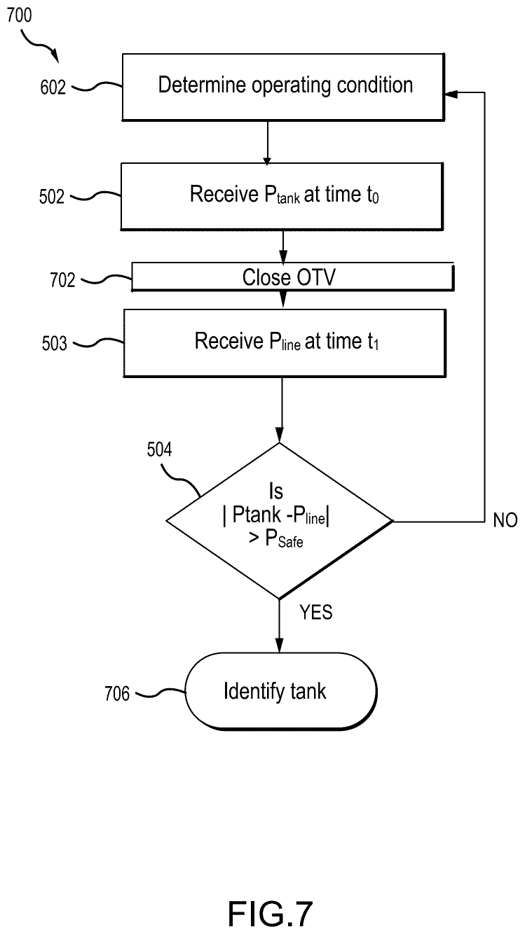

With reference to FIG. 7, valve diagnostic 700 is illustrated. Valve diagnostic 700 contains several components of valve diagnostic 600, which is discussed above. Receive Pₜₐₙₖ 502 may occur where every tank in tanks 302, 304, 306, 308, and 310 has Pₜₐₙₖ read from an associated OTV pressure sensor and/or associated EP pressure sensor. Thus, a Pₜₐₙₖ is measured for each of tanks 302, 304, 306, 308, and 310.

Tanks 302, 304, 306, 308, and 310 are commanded to close its OTVs (or OTVs commanded to close directly) in close OTV 702. The duration of the closing of OTVs 312, 320, 330, 340, and 350 may be a function of temperature and pressure at manifold 360 and/or tanks 302, 304, 306, 308, and 310. For example, for a constant temperature, the time for which OTVs 312, 320, 330, 340, and 350 may be closed decreases as pressure increases. This relationship maybe stored in a lookup table or other memory. In this manner, the time for which OTVs 312, 320, 330, 340, and 350 are closed is known, being driven by the temperature and pressure of manifold 360.

Receive Pₗᵢₙₑ 503 occurs as well as comparison 504. Valve diagnostic 700 is thus performed at once for the tank array. For each tank array where the absolute value of Pₜₐₙₖ−Pₗᵢₙₑ >P_{safe}, identify tank 706 identifies the tank for which the OTV is stuck open. Identify tank 706 is a stuck OTV fault diagnostic process.

It should be noted that since tanks 302, 304, 306, 308, and 310 have both an inlet and an outlet, it is not necessary to command to open OTVs 312, 320, 330, 340, and 350 prior to the start of any diagnostic method herein. Since OTVs 312, 320, 330, 340, and 350 begin in the open state, the speed with which the diagnostic method is performed is increased.

Moreover, valve diagnostic 500, 600, 700, 800 and 1000 may delayed or halted in response to a variety of conditions. For example, if any pressure sensor is known to be defective or if an OTV's operational status is known to be defective.

Any of the systems and methods disclosed herein may be implemented with varying combinations of hardware, software, communications and/or networking interfaces, and various mechanical machinery including valve actuators, mechanical actuators, display devices, haptic feedback devices, and other hardware capable of receiving a command and converting electrical energy, in response to said command, into mechanical motion.

Computer programs (also referred to as computer control logic) are stored in main memory and/or secondary memory. Computer programs may also be received via communications interface. These computer program instructions may be loaded onto a general purpose computer, special purpose computer, controller, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer, controller, or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor or controller, causes the processor or controller to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment (e.g., an internet-based driving command system), an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including: hard disks, solid state storage media, CD-ROM, BLU-RAY DISC®, optical storage devices, magnetic storage devices, and/or the like.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any suitable programming or scripting language such as C, C++, C#, JAVAR, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML), with the various algorithms being implemented with any combination of data structures, objects, processes, routines, and/or other programming elements. Further, it should be noted that the system may employ any number of techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment, for example: A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A hydrogen storage system for a fuel cell electric vehicle (FCEV), the system comprising:
a controller in electronic communication with an on tank valve (OTV) associated with an OTV of a first tank;
a pressure regulator pressure sensor associated with a pressure regulator in electronic communication with the controller, the pressure regulator being in fluid communication with at least one of a fuel cell supply line, a manifold, or a plumbing system, wherein the pressure regulator pressure sensor is configured to sense a pressure in the at least one of the fuel cell supply line, the manifold, or the plumbing system; and
a non-transitory computer-readable storage medium in electronic communication with the controller, having instructions stored thereon that, in response to execution by the controller, cause the controller to perform operations comprising:
receiving, by the controller and during at least one of a driving condition, a park preparation condition, or a low fuel cell power demand condition, a first pressure from the pressure regulator pressure sensor representing at least one of the fuel cell supply line, the manifold, or the plumbing system;
commanding, by the controller, the OTV to close for a predetermined time interval;
receiving, by the controller, a second pressure from the pressure regulator pressure sensor representing at least one of the fuel cell supply line, the manifold, or the plumbing system;
determining, by the controller, the absolute value of the difference between the first pressure and the second pressure to yield an absolute pressure difference;
determining, by the controller, whether the absolute pressure difference is greater than a predetermined threshold; and
in response to finding that the absolute pressure difference is less than the predetermined threshold, transmitting, by the controller, a stuck OTV fault.

2. The hydrogen storage system of claim 1, wherein the controller transmits the stuck OTV fault to a controller area network (CAN) bus.

3. The hydrogen storage system of claim 1, wherein the hydrogen storage system further comprises a regulator in electronic communication with the controller.

4. The hydrogen storage system of claim 1, wherein the operations are commenced in response to at least one of: the driving condition, the park preparation condition, or the fuel cell power demand condition.

5. The hydrogen storage system of claim 4, wherein the commanding, by the controller, the OTV to close occurs prior to the receiving the first pressure.

6. The hydrogen storage system of claim 5, wherein the instructions further comprise waiting, by the controller, after the commanding the first tank OTV to close and prior to the receiving the second pressure, for the predetermined time interval.

7. The hydrogen storage system of claim 1, further comprising a fueling valve of the first tank, wherein the instructions further comprise commanding, by the controller and prior to the receiving the first pressure, the OTV to close.

8. The hydrogen storage system of claim 7, wherein the instructions further comprise:
in response to finding that the absolute pressure difference is greater than the predetermined threshold initiating, by the controller, a stuck OTV fault diagnostic process.

9. An article of manufacture including a tangible, non-transitory computer-readable storage medium in electronic communication with a controller, having instructions stored thereon that, in response to execution by the controller, cause the controller to perform operations comprising:
receiving, by the controller and during at least one of a driving condition, a park preparation condition, or a low fuel cell power demand condition, a first pressure from a pressure regulator pressure sensor representing at least one of a fuel cell supply line, a manifold, or a plumbing system;
commanding, by the controller, an on tank valve (OTV) to close for a predetermined time interval;
receiving, by the controller, a second pressure from the pressure regulator pressure sensor representing at least one of the fuel cell supply line, the manifold, or the plumbing system;
determining, by the controller, the absolute value of the difference between the first pressure and the second pressure to yield an absolute pressure difference;
determining, by the controller, whether the absolute pressure difference is greater than a predetermined threshold; and
in response to finding that the absolute pressure difference is greater than the predetermined threshold, transmitting, by the controller, a stuck OTV fault.

10. The article of manufacture of claim 9, wherein the instructions further comprise transmitting, by the controller, the stuck OTV fault to a controller area network (CAN) bus.

11. The article of manufacture of claim 9, wherein the operations are commenced in response to at least one of: the driving condition, the park preparation condition, or the fuel cell power demand condition.

12. The article of manufacture of claim 11, wherein the commanding, by the controller, the OTV to close occurs prior to the receiving the first pressure.

13. The article of manufacture of claim 12, wherein the instructions further comprise waiting, by the controller, after the commanding the first tank OTV to close and prior to the receiving the first pressure, for the predetermined time interval.

14. The article of manufacture of claim 9, wherein the instructions further comprise waiting, by the controller after the commanding the first tank OTV to close and prior to the receiving the second pressure, for the predetermined time interval.

15. A method, comprising:
receiving, by a controller and during at least one of a driving condition, a park preparation condition, or a low fuel cell power demand condition, a first pressure from a pressure regulator pressure sensor representing at least one of a fuel cell supply line, a manifold, or a plumbing system;
commanding, by the controller, an on tank valve (OTV) to close for a predetermined time interval;
receiving, by the controller, a second pressure from the pressure regulator pressure sensor;
determining, by the controller, the absolute value of the difference between the first pressure and the second pressure to yield an absolute pressure difference;
determining, by the controller, whether the absolute pressure difference is greater than a predetermined threshold; and
in response to finding that the absolute pressure difference is greater than the predetermined threshold, transmitting, by the controller, a stuck OTV fault.

16. The method of claim 15, further comprising transmitting, by the controller, the stuck OTV fault to a controller area network (CAN) bus.

17. The method of claim 15, wherein operations are commenced in response to at least one of: the driving condition, the park preparation condition, or the fuel cell power demand condition.

18. The method of claim 17, wherein the operations further comprise commanding, by the controller and prior to the receiving the first pressure, the first tank OTV to close.

19. The method of claim 18, further comprising a fueling valve of a first tank, wherein the instructions further comprise commanding, by the controller and prior to the receiving the first pressure, the OTV to close.

20. The method of claim 19, wherein the instructions further comprise:
in response to finding that the absolute pressure difference is greater than the predetermined threshold, initiating, by the controller, a stuck OTV fault diagnostic process.
